(19) United States
(12) Patent Application Publication
(10) Pub. No.: US 2011/0174117 A1
(43) Pub. Date: Jul. 21, 2011

(54) Fastener holder for starting a threaded fastner into a difficult-to-access hole

(76) Inventor: Louis J. Franco, Lunenburg, MA (US)

(21) Appl. No.: 12/930,349

(22) Filed: Jan. 4, 2011

Related U.S. Application Data
(60) Provisional application No. 61/335,251, filed on Jan. 4, 2010.

(51) Int. Cl. B25B 23/10

(52) U.S. Cl. 81/44

(57) ABSTRACT

A fastener holder is configured for starting into a threaded hole an elongated threaded fastener having a threaded fastener stem. The fastener holder includes an arm that extends longitudinally along an arm axis and has a distal end from which depend first and second opposed fastener-gripping members that are alternatively displaceable along a first plane toward and away from one another between a fastener-gripping position and a fastener-releasing position. The fastener-gripping members are oriented relative to the arm such that the first plane is orthogonal to the arm axis. A fastener-gripping position is such that the fastener-gripping members are biased toward one another and a fastener stem situated between the fastener-gripping members is retained by a constrictive force exerted by the fastener-gripping members on the fastener stem. A fastener-releasing position is such that, relative to the same fastener, the fastener-gripping members are spread farther apart than in a fastener-gripping position in order to facilitate the lateral release of the fastener stem from the fastener-gripping members.

### PROVISIONAL PRIORITY CLAIM

Priority based on Provisional Application Ser. No. 61/335,251 filed Jan. 4, 2010, and entitled “THREADED-FASTENER HOLDER FOR USE WITH FASTENER DRIVER” is claimed. The entirety of the disclosure of the previous provisional application, including the drawings, is incorporated herein by reference as if set forth fully in the present application.

### BACKGROUND

Occasions arise in which a person is confronted with threading an elongated threaded fastener (e.g. a screw or bolt) into a difficult-to-access threaded hole. For instance, a threaded hole may reside within a deep channel or be obstructed by interfering objects and structures, such as in the engine compartment of an automobile, for example.

Devices have previously been developed for guiding elongated threaded fasteners into difficult-to-reach recesses. A first includes an elongated rigid shaft having a handle at one end and, at the opposite, distal end of the shaft, a socket-type member including a magnetic channel into which the keyed head of a threaded fastener is inserted and retained temporarily by magnetic attraction between the fastener and the socket member. With the fastener temporarily retained at the distal end, the fastener is guided by the user into the hole into which it is to be threaded. The user generally starts the fastener into the hole with this device and, once the threaded hole can support the fastener, removes the guiding device and threads the fastener in the remainder of the way with, for example, a screwdriver. The usefulness of such a device is, of course, limited to use with fasteners made from metals that are responsive to the presence of a magnetic field, and cannot be used with plastic, brass, aluminum or stainless steel fasteners, for example.

Another existing threaded-fastener holding device includes an elongated shaft having a handle at one end and a pair of selectively spreadable leaf or reed members at the distal end opposite the handle end. As a practical matter, the usefulness of this device is limited to the starting of flathead screws or bolts into threaded holes. This device is used by inserting the leaf pair into the key slot (i.e., groove) at the head of a flathead screw. Once the leaves are situated within the groove, the leaves are selectively urged apart until they frictionally engage the side surfaces of the groove, thereby temporarily holding the screw in place with respect to the shaft of the device. In a manner generally described in connection with the first-described prior device, the screw is then guided and started into the remotely located threaded hole. Once the fastener is supported by the threaded hole, the leaves of the fastener guide are is withdrawn from the groove of the screw and the threading of the screw into the hole is completed with a standard flathead screwdriver. As previously alluded to, this device is typically not useable with other than flathead screws, thereby limiting its usefulness to a relatively narrow class of fasteners. Moreover, extreme care is required in order to avoid premature dislodging of the screw from the hold of the spread leaves.

Accordingly, there exists a need for a threaded-fastener holder with more universal application than each of the illustrative devices previously described. More specifically, a need exists for a threaded-fastener holder whose usefulness is not limited by the materials from which a fastener is fabricated or by the type of keyed head a fastener has and which, in any event, maintains a more reliable temporary hold upon a threaded fastener.

### SUMMARY

Embodiments of the present invention are directed to holders for the temporary retention of an elongated threaded fastener in order to drive such a fastener into a difficult-to-access hole. In one embodiment, a threaded-fastener holder is selectively attachable to a threaded-fastener driver configured for driving an elongated fastener of the general type including a threaded fastener stem, which may be partially or fully threaded along its length, and a keyed fastener head at one end of the stem. The driver to which the fastener holder is attachable typically includes an elongated driver shaft with a handle end and a keyed driver head opposite the handle end. The keyed driver head is configured for selective cooperative engagement with the keyed fastener head of the threaded fastener, thereby permitting the transfer of rotational force (i.e., torque) from the driver to the fastener. One non-limiting example of such a fastener driver is a screwdriver.

In one version, the fastener holder includes an elongated, substantially rigid arm that extends longitudinally along an arm axis between proximal and distal ends. Depending from the distal end are opposed first and second fastener-gripping members. The fastener-gripping members are displaceable (e.g., flexible or pivotable in alternative versions) toward and away from one another along, but not necessarily parallel to, a first plane. The fastener-gripping members are oriented with respect to the arm such that the first plane is perpendicular to the arm axis. A fastener-gripping position is such that the stem of a threaded fastener positioned between the first and second fastener-gripping members is retained therebetween by a constrictive force exerted by the fastener-gripping members on the fastener stem. A fastener-releasing position is such that the stem of a threaded fastener can be urged laterally free of the fastener-gripping members. It will be appreciated that, with respect to a particular threaded fastener, a fastener-releasing position is such that the fastener-gripping members are more open (i.e., spread farther apart) than a fastener-gripping position.

In one illustrative version, the arm of the fastener holder is selectively attachable to the driver shaft such that the first and second fastener-gripping members are more distant from the handle end of the driver shaft than is the keyed driver head. Thus attached, the fastener stem can be temporarily retained between the fastener-gripping members with the keyed fastener head and the keyed driver head cooperatively engaged.

In each of various versions, the first and second fastener-gripping members are made from a resilient material having a memory property that normally biases them into a first position with respect to one another. This first position is the “normal” or “non-flexed” position of the fastener-gripping members when, for instance, there is no fastener retained between them. When a fastener stem is retained between and by the fastener-gripping members, the fastener-gripping members are in a second, fastener-gripping position in which the fastener-gripping members are more spread apart relative to the first position. Because of the memory property of the material from which they are made, the fastener-gripping members experience a biasing force when in a fastener-gripping position, which biasing force biases them toward the less spread-apart (i.e., more closed) first position. It will be appreciated that, when the fastener-gripping members are in a fastener-gripping position, they are spread apart to a greater or lesser degree, depending on the diameter of the fastener stem situated therebetween.

In a typical version, the fastener-gripping members are disengageable from the fastener stem by application of a properly directed force having a spatial-displacement component perpendicular to the fastener stem axis (i.e., a laterally-directed force). When a force so directed is of sufficient magnitude, the fastener-retaining members spread to a fastener-releasing position that is more open than the fastener-retaining position for a particular fastener and accommodates the lateral separation of the fastener stem and the fastener-retaining members.

In one embodiment, at least one of the fastener-gripping members includes an interior, substantially concave support surface configured to accommodate a portion of the generally cylindrical side surface of a threaded fastener such as a bolt or screw, for example. To further enhance fastener gripping, the interior support surface in one or more alternative versions includes material conducive to a sufficiently high coefficient of friction between itself and the fastener material so as to frictionally support the fastener between the fastener-gripping members. For instance, the interior support surfaces could include rubber or a polymer to facilitate frictional engagement with a fastener.

In various embodiments configured for selective attachment to a fastener driver, the fastener holder includes a driver-shaft retainer for selectively attaching the fastener holder to a driver shaft. In an illustrative version, the retainer depends from the proximal end of the arm and comprises first and second shaft-engaging jaws that move toward and away from one another for the selective retention of a driver shaft therebetween. More specifically, the shaft-engaging jaws cooperate to grip and release a driver shaft in a manner similar to the manner in which the fastener-gripping members grip a fastener stem. In one specific version, at least one, but preferably both, of the first and second shaft-engaging jaws includes a concave inner surface to accommodate a portion of the generally cylindrical side surface of a driver shaft.

In an illustratively configured fastener holder including shaft-engaging jaws, the first and second shaft-engaging jaws are displaceable toward and away from one another along, but not necessarily parallel to, a second plane that is parallel to the first plane along which the fastener-gripping members are displaceable. In this way, the fastener holder can be attached to a driver shaft with a threaded fastener retained between the fastener-gripping members such that the keyed head of the fastener driver is situated in mating engagement with the keyed head of the fastener in the space between the longitudinally separated fastener-gripping members and shaft-retaining jaws. Typically, when the fastener holder, the threaded fastener and the driver shaft are so situated, the driver shaft extends along a shaft axis that is one of (i) substantially parallel to and (ii) co-linear with the stem axis.

It will be readily appreciated that, in versions that are attachable to a fastener driver, the attachment maintaining the fastener holder on the driver shaft should be more resistant to separation from the driver shaft than are the first and second fastener-gripping members from a fastener stem. Circumstances in which the preceding condition is not met could result in a fastener's being partially threaded into a hole and, when a lateral force is applied, the unintended separation of the fastener holder and the driver shaft, thereby leaving the fastener holder attached to the fastener.

An alternatively embodied fastener holder is in the form of a “stand-alone” device. More specifically, such a fastener holder is configured with the proximal end of the arm elongated to serve as a handle end. The handle end is optionally attached to a handle that, in an illustrative version, has an enlarged cross-sectional area relative to the arm as viewed into a plane perpendicular to the arm axis, similar to the relationship between a screwdriver shaft and the handle carried thereby. The distal end of the arm, and the fastener-gripping members carried thereby, may be configured similarly to the corresponding components of the attachable versions previously described.

In alternative versions of both “stand-alone” and “attachable” embodiments, the fastener-gripping members are rigid (inflexible) elements. In such a case, the first and second fastener-gripping members might depend from the elongated arm such that they pivot toward and away from one another about the same pivot axis or separate pivot axes, defined by one or two pivot pins, for example. Furthermore, in an alternative version, one of the first and second fastener-gripping members is fixed in a stationary position with respect to the elongated arm while the other of the first and second fastener-gripping members pivots toward and away from the other fastener-gripping member. In still another version, one fastener-gripping member is rigid and fixed relative to the arm while the other fastener-gripping member is made from a resilient material that facilitates its being flexed toward and away from the stationary fastener-gripping member. In any of these illustrative scenarios, the first and second fastener-gripping members are still displaceable with respect to one another. It will be furthermore appreciated that in “attachable” embodiments, the shaft-retaining jaws can be configured and mechanically biased similarly to the manners in which any of the alternatively embodied fastener-gripping members are configured and biased.

Representative embodiments are more completely described and depicted in the following detailed description and the accompanying drawings.

### BRIEF DESCRIPTION OF THE DRAWINGS

FIG. 1 shows a fastener holder configured for use in conjunction with a threaded-fastener driver;

FIG. 2 is a view of the fastener holder of FIG. 1 in which a threaded fastener is retained between fastener-gripping members of the holder while the holder is attached to a threaded-fastener driver;

FIG. 2A depicts the fastener holder of FIGS. 1 and 2 in which the fastener-gripping members thereof are in a fastener-releasing position;

FIG. 3 shows an alternative fastener holder including an elongated arm extending between and connecting fastener-gripping members depending from one end and a handle; and

FIG. 4 depicts a fastener holder including fastener-gripping members mechanically biased toward one another by an independent biasing member.

### DETAILED DESCRIPTION

The following description of variously embodied fastener holders is demonstrative in nature and is not intended to limit the invention or its application of uses. Accordingly, the various implementations, aspects, versions and embodiments described in the summary and detailed description are in the nature of non-limiting examples falling within the scope of the appended claims and do not serve to define the maximum scope of the claims.

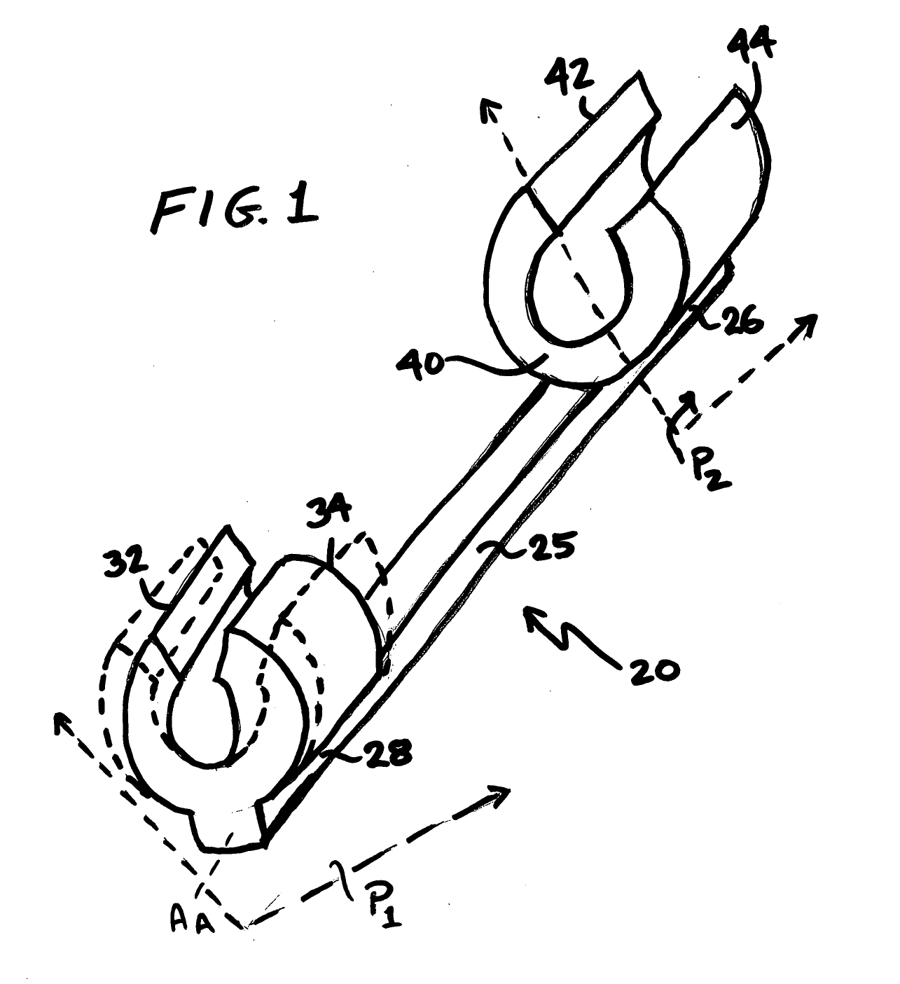

With initial reference to FIG. 1, an illustrative threaded-fastener holder 20 (or simply, fastener holder 20) includes an elongated arm 25 that extends longitudinally along an arm axis A_{A} between proximal and distal ends 26 and 28. Depending from the distal end 28 of the arm 25 are opposed first and second fastener-gripping members 32 and 34. The fastener-gripping members 32 and 34 are selectively displaceable toward and away from one another along a first plane P₁ between a first, non-retaining position, as indicated in solid outlines in FIG. 1, and more open (i.e., spread apart) positions, an example of which is indicated in phantom outlines. As indicated in FIG. 1, the first plane P₁ is perpendicular to the arm axis A_{A}.

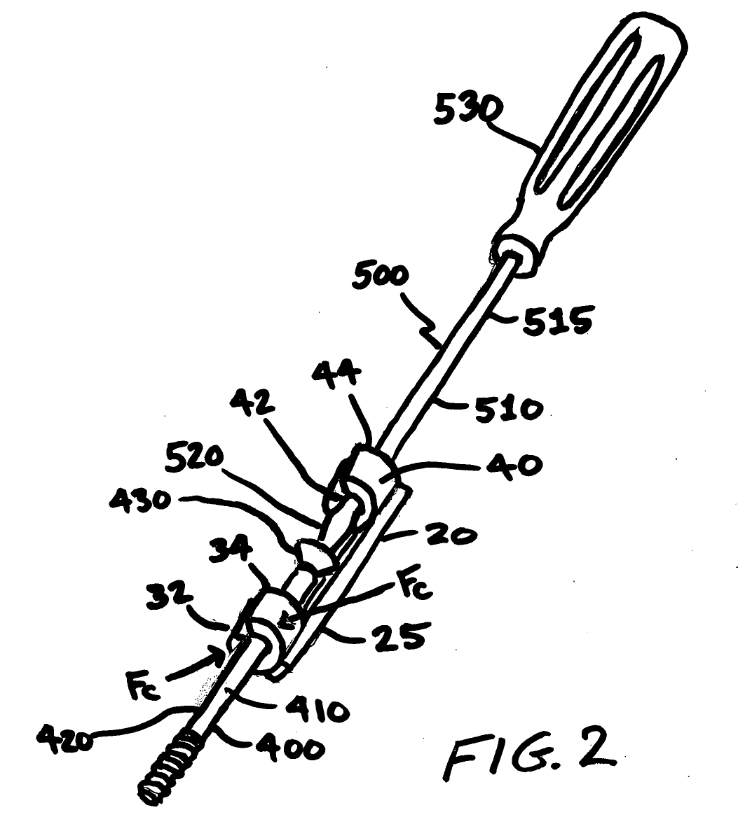

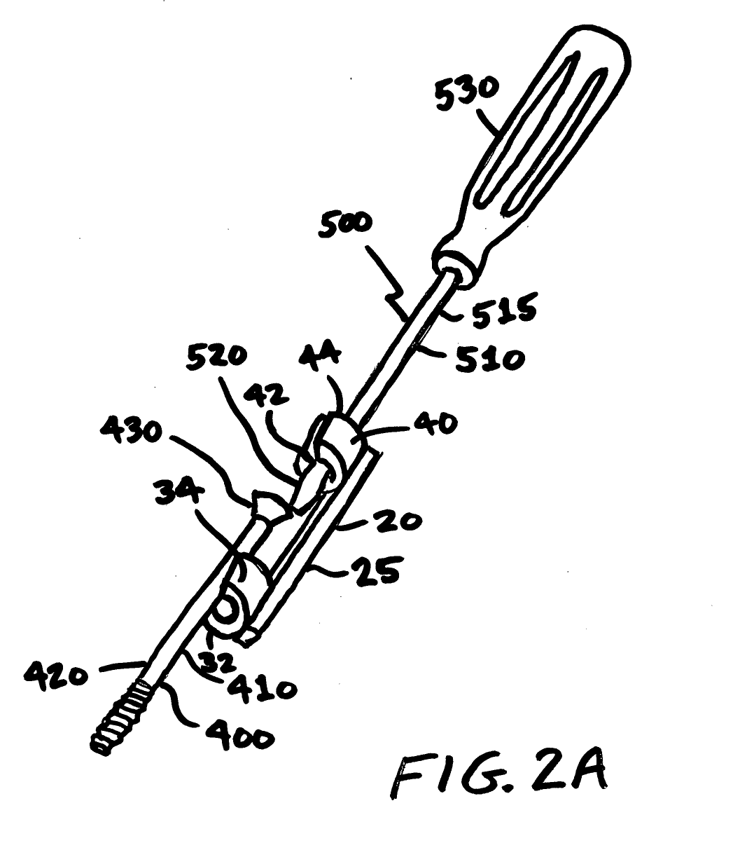

As illustrated in FIG. 2, a fastener-gripping position is such that the stem 410 of a threaded fastener 400 positioned between the first and second fastener-gripping is members 32 and 34 is retained therebetween by a constrictive force F_{c} exerted by the fastener-gripping members 32 and 34 on the side surface 420 of the fastener stem 410. A fastener-releasing position, such as that shown in FIG. 2A, is such that a fastener stem 410 can be urged laterally free of the fastener-gripping members 32 and 34. Although the fastener-gripping members 32 and 34 will be spread apart to a similar extent when a fastener stem 410 is removed from or inserted between the fastener-gripping members—and, therefore, the resultant position of the fastener-gripping members could equally be referred to as a fastener-inserting position—each such position is referred to as a fastener-releasing position throughout the specification and claims for consistency and simplicity. Typically, with respect to a particular threaded fastener 400, a fastener-releasing position like that shown in 2A represents a position in which the fastener-gripping members 32 and 34 are more open (i.e., spread farther apart) than a fastener-gripping position for the same fastener 400.

Referring again to FIG. 2, a fastener holder 20 is shown attached to the elongated driver shaft 510 of an illustrative threaded-fastener driver 500. The threaded-fastener driver 500 includes the driver shaft 510, which driver shaft 510 has a handle end 515 and a keyed head end 520, and a handle 530 attached to the handle end 515. The arm 25 of the fastener holder 20 is selectively attachable to the driver shaft 510 such that the first and second fastener-gripping members 32 and 34 are more distant from the handle end 515 of the driver shaft 510 than is the keyed driver head 520. When the fastener holder 20 is attached to the driver shaft 510 as generally shown in FIG. 2, a fastener stem 410 can be inserted and temporarily retained between the fastener-gripping members 32 and 34 with the keyed fastener head 430 and the keyed driver head 520 cooperatively engaged. After starting the fastener 400 into an otherwise difficult-to-access threaded hole (not shown), a laterally-directed force can be transferred from the driver 500 to the fastener holder 20 to spread the fastener-gripping members and release the fastener stem 410.

In the “attachable” embodiment of FIGS. 1 through 2A, the arm 25 is attachable to a driver shaft 510 through a driver-shaft retainer 40. The retainer 40 depends from the proximal end 26 of the arm 25 and comprises first and second shaft-engaging jaws 42 and 44 that are displaceable toward and away from one another for the selective retention of a driver shaft 510 therebetween. More specifically, the shaft-engaging jaws 42 and 44 cooperate to grip and release a driver shaft 510 in a manner similar to the manner in which the fastener-gripping members 32 and 34 grip a fastener stem 410. Accordingly, the first and second shaft-engaging jaws 42 and 44 are displaceable toward and away from one another along, but not necessarily parallel to, a second plane P₂ that is parallel to the first plane P₁ along which the fastener-gripping members 32 and 34 are displaceable.

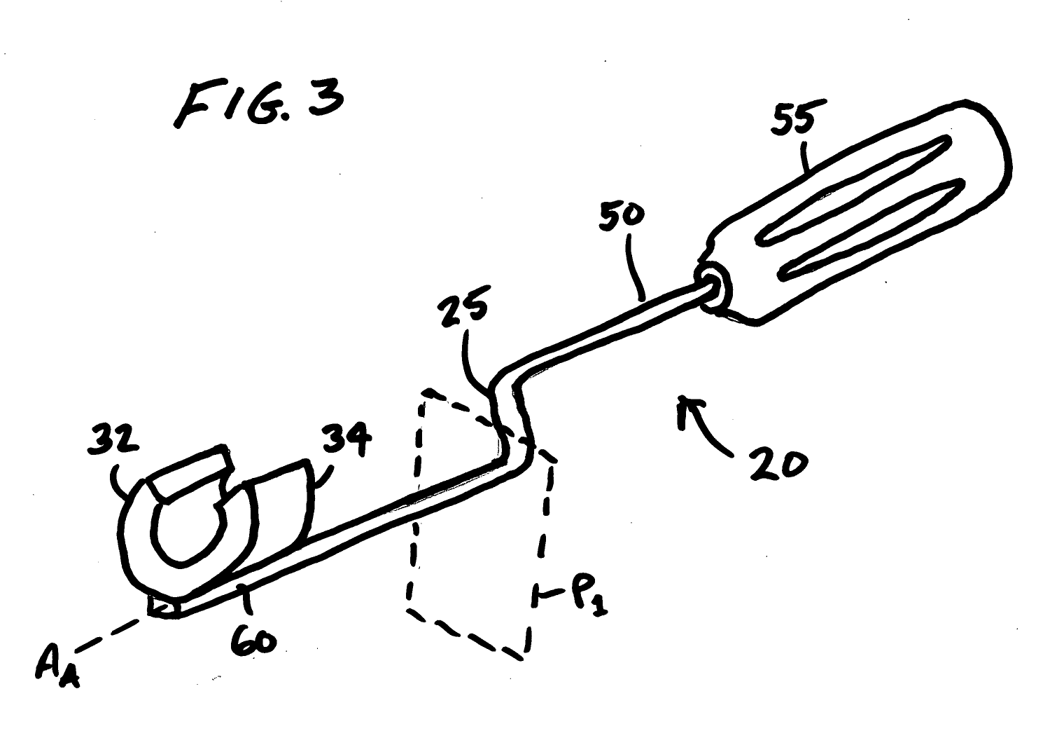

In an alternative embodiment, discussed with principal reference to FIG. 3, in which components analogous to those of the version of FIG. 1 are similarly numbered, a fastener holder 20 includes an elongated arm 25 extending longitudinally along an arm axis A_{A}. The arm 25 has longitudinally opposed handle (or proximal) and distal ends 50 and 60, the handle end 50 including a handle 55 configured for direct grasping by a user's hand. Depending from the distal end 60 of the arm 25 are opposed first and second fastener-gripping members 32 and 34.

In a manner analogous to the fastener-gripping members 32 and 34 associated with the embodiment of FIG. 1, the fastener-gripping members 32 and 34 in the embodiment of FIG. 3 are alternatively displaceable toward and away from one another along a first plane P₁ oriented orthogonally to the arm axis A_{A}. Moreover, as with the version of FIG. 1, the fastener-gripping members 32 and 34 in the version of FIG. 3 are displaceable between a fastener-gripping position and a fastener-releasing position, which positions are defined similarly among alternative embodiments. More specifically, in each case, as described with reference to FIGS. 1, 2 and 2A, the fastener-gripping position is such that the fastener-gripping members 32 and 34 are biased toward one another and a fastener stem 410 situated between the fastener-gripping members 32 and 34 is retained by a constrictive force F_{c} exerted by the fastener-gripping members 32 and 34 on the fastener stem 410, while the fastener-releasing position is such that, relative to the same fastener 400, the fastener-gripping members 32 and 34 are spread farther apart than in a fastener-gripping position in order to facilitate the lateral separation of the fastener stem 410 and the fastener-gripping members 32 and 34. Because illustrative fastener-gripping and fastener-releasing positions are shown in association with the version of FIGS. 1, 2 and 2A, and these positions are analogous relative to the version of FIG. 3, redundancy is obviated by not showing such positions explicitly in association with the version of FIG. 3.

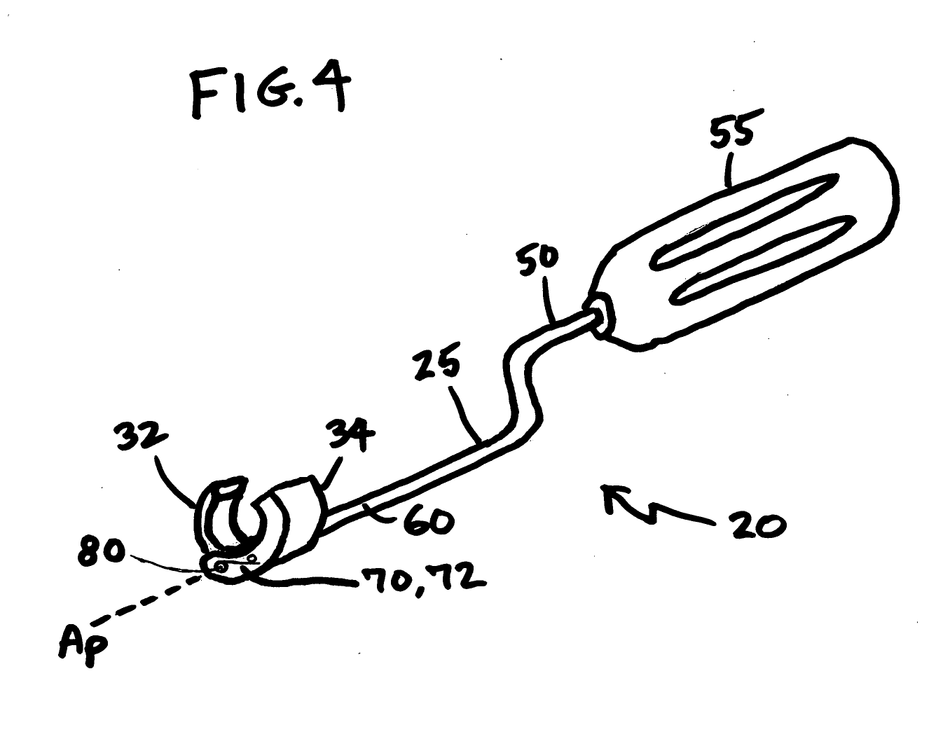

In the versions previously described with reference to FIGS. 1 through 3, the fastening-gripping members 32 and 34 are made from a resilient material with a memory property such that, at least when they are urged apart, they are mechanically biased toward a more closed position. Illustrative materials from which such flexible fastener-gripping members 32 and 34 can be fabricated include rubber, plastic, and metal, by way of non-limiting example. In alternative embodiments, described with illustrative reference to FIG. 4, the fastener-gripping members 32 and 34 could be either rigid or flexible, but are, in any event, at least when urged apart, mechanically biased toward one another by an independent biasing member 70 acting on at least one of the first and second fastener-gripping members 32 and 34. In the particular, non-limiting example of FIG. 4, the fastener-gripping members 32 and 34 pivot about a common pivot pin 80 defining a pivot axis A_{P} and are mechanically biased by a torsion spring 72 carried by the pivot pin 80.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and versions shown and described.

What is claimed is:

1. A threaded-fastener holder for selective attachment to a threaded fastener driver configured for driving an elongated threaded fastener including a threaded fastener stem and a keyed fastener head at one end of the stem, the driver having an elongated driver shaft with a handle end and a keyed driver head opposite the handle end, the keyed driver head for selectively cooperatively engaging the keyed fastener head, the fastener holder comprising:
an arm extending longitudinally along an arm axis and having longitudinally opposed proximal and distal ends; and
first and second opposed fastener-gripping members depending from the distal end and being displaceable toward and away from one another between a fastener-gripping position and a fastener-releasing position, the fastener-gripping members being displaceable along a first plane that is perpendicular to the longitudinal axis of the arm, the proximal end of the arm being selectively attachable to the driver shaft such that the first and second fastener-gripping members are more distant from the handle end of the driver shaft than is the keyed driver head and such that the stem of a threaded fastener can be temporarily retained between the gripping members with the keyed fastener head and the keyed driver head cooperatively engaged.

2. A fastener holder configured for starting into a threaded hole an elongated threaded fastener having a threaded fastener stem, the fastener holder comprising:
an arm extending longitudinally along an arm axis and having a distal end; and
first and second opposed fastener-gripping members depending from the distal end and being alternatively displaceable along a first plane toward and away from one another between a fastener-gripping position and a fastener-releasing position; wherein
(i) the first plane is orthogonal to the arm axis;
(ii) the fastener-gripping position is such that the fastener-gripping members are biased toward one another and a fastener stem situated between the fastener-gripping members is retained by a constrictive force exerted by the fastener-gripping members on the fastener stem; and
(iii) the fastener-releasing position is such that, relative to the same fastener, the fastener-gripping members are spread farther apart than in a fastener-gripping position in order to facilitate the lateral separation of the fastener stem and the fastener-gripping members.

3. The fastener holder of claim 2 wherein the arm further comprises a handle end longitudinally opposed to the distal end.

4. The fastener holder of claim 3 further comprising a handle attached to the handle end of the arm.

5. The fastener holder of claim 2 wherein the arm further comprises a proximal end from which depend first and second shaft-retaining jaws configured for selectively retaining therebetween the driver shaft of a threaded-fastener driver.

6. A fastener holder configured for starting into a threaded hole an elongated threaded fastener having a fastener stem that is at least partially threaded and extends longitudinally along a stem axis, the fastener holder comprising:
an elongated arm extending longitudinally along an arm axis and having longitudinally opposed handle and distal ends; and
first and second opposed fastener-gripping members depending from the distal end of the arm and being alternatively displaceable along a first plane toward and away from one another between a fastener-gripping position and a fastener-releasing position; wherein
(i) the first plane is orthogonal to the arm axis;
(ii) the fastener-gripping position is such that the fastener-gripping members are biased toward one another and a fastener stem situated between the fastener-gripping members is retained by a constrictive force exerted by the fastener-gripping members on the fastener stem; and
(iii) the fastener-releasing position is such that, relative to the same fastener, the fastener-gripping members are spread farther apart than in a fastener-gripping position in order to facilitate the lateral separation of the fastener stem and the fastener-gripping members.

7. The fastener holder of claim 6 wherein at least one of the fastener-gripping members is fabricated from a resilient material with a memory property.

8. The fastener holder of claim 6 wherein each of the first and second fastener-gripping members is fabricated from a resilient material with a memory property.

9. The fastener holder of claim 6 wherein, at least when they are urged apart, the fastener-gripping members are mechanically biased toward one another by a biasing member acting on at least one of the first and second fastener-gripping members.
